(19) United States
(12) Patent Application Publication
(10) Pub. No.: US 2022/0157187 A1
(43) Pub. Date: May 19, 2022

(54) INVISIBLE OBSERVATION MODE IN THE ONLINE LEARNING PROCESS

(71) Applicant: Mark Aleksandrovich NECHAEV, Krasnoyarskiy kray, (RU)

(72) Inventor: Faisal Ashfaq Satti Mohammad, Islamabad (PK)

(21) Appl. No.: 17/602,784

(22) PCT Filed: Apr. 16, 2019
(86) PCT No.: PCT/RU2019/000254

§ 371 Date: Oct. 11, 2021

(51) Int. Cl. G09B 5/06

(52) U.S. Cl. CPC G09B 5/065

(57) ABSTRACT

A mode of invisible observation in online learning process is provided. The mode allows us to solve technical problem of insufficient efficiency and productivity of online learning caused by individual nature of this training, including when it can be carried out at home, because of which teacher and student are distracted from the subject of training, aren't sufficiently concentrated, and also caused by lack of a system for monitoring quality of teacher's work. The technical result is achieved by the fact the teacher, student, and parents or other legal representatives of the student, hereafter observers, take part in the online learning process, while the observers can observe the learning process, the teacher and student don't know whether the observers are watching the online learning process, when the observers begin and end the observation, moreover, an online training session can be recorded for its subsequent viewing and analysis by the observers.

### CROSS-REFERENCE TO RELATED APPLICATIONS

This application is a national stage application of the Patent Cooperation Treaty (PCT) international application titled “INVISIBLE OBSERVATION MODE IN THE ONLINE LEARNING PROCESS”, international application number PCT/RU2019/000254, filed in the Russian Patent Office on Apr. 16, 2019. The specification of the above referenced Patent application is incorporated herein by reference in its entirety.

### FIELD OF THE INVENTION

The invention relates to the field of application of learning tools with an individual connection between the teacher and each student, namely, to the field of individual online distance learning and can be applied to increase the efficiency and productivity of online learning.

### BACKGROUND

A technical solution is known under the international patent for the invention No FR2814844 (priority date 20 Oct. 2000) “Online training via the Internet, in which teachers, students and the administration and resource server can connect to each other, allowing data exchange, updating results, etc.” This technical solution is characterized by the fact that the online training method is used for one or more students, one or more tutoring clients connected via the Internet to a database server containing data related to an interactive course. The server also has knowledge bases that can be queried by clients using a query generator, software to facilitate data exchange between client students and client teachers, and to record part of at least the data exchanged to make it possible to analyze the results. A file is generated from the results, which can be imported by a parent or guardian. The following essential features of this technical solution coincide with the claimed technical solution “Invisible observation mode in the process of online learning”: this method is intended for online learning, the participants of which are students, teachers and parents (guardians).

The closest technical solution (prototype) is the technical solution under the international patent for the invention No. CN 10665261 (priority date 10 Mar. 2017) “Bi directional distance learning system using a computer”. This technical solution is characterized by the fact that it reveals a bidirectional distance learning system using a computer. A bidirectional distance learning system contains a student module, a parent module, a teacher module, a communication module and a storage module, wherein the student module, the parent module and the teacher module are electrically connected to the communication module in two directions; the output end of the communication module is electrically connected to the input end of the storage module; and the student module and the teacher module are electrically connected to the storage module in two directions. The bidirectional computer-based distance learning system disclosed in the invention is equipped with a special communication module, so that teachers and students, as well as teachers and parents can conveniently communicate and know each other very well; the module for testing the learning conditions of students is organized in such a way that students can pass step-by-step testing, and, in addition, teachers can give appropriate instructions to students; Meanwhile, parents can view the students' testing conditions in real time, so that parents can easily find out how the student learning process is progressing. Thus, the bidirectional distance learning system is convenient for use by students, parents and teachers. The following essential features of this technical solution coincide with the claimed technical solution “Invisible observation mode in the process of online learning”: this system is designed for distance learning using a computer and at the same time provides for the participation of a student, teacher and parents at the same time. Moreover, parents can view the learning process in real time.

The technical solutions listed above have a number of disadvantages:
in the technical solution for the patent for the invention CN10665261, the participation of parents is limited to viewing the testing conditions of students, while only a computer is specified as a teaching tool;
the technical solution for the patent for the invention a FR2814844 does not provide for the participation of parents directly in the learning process, they only see the learning results in the generated file, which does not give them the opportunity to analyze the entire process of interaction between the teacher and the student and monitor the work of the teacher whose services they pay for; and
in technical solutions for patents for inventions No. FR2814844, CN10665261, students and teachers know in advance about the participation of parents, in connection with which they can specifically demonstrate a high-quality learning process in the case of parents' participation, and without their participation distract from the subject of training.

### SUMMARY OF THE INVNETION

Invisible observation mode in the online learning process.

The invention relates to the field of application of learning tools with an individual connection between the teacher and each student, namely, to the field of individual online distance learning and can be applied to increase the efficiency and productivity of online learning.

The claimed mode of invisible observation in the process of online learning allows us to solve the technical problem of insufficient efficiency and productivity of online learning caused by the individual nature of this training, including when it can be carried out at home, because of which the teacher and student are distracted from the subject of training, are not sufficiently concentrated, and also caused by the lack of a system for monitoring the quality of the teacher's work.

The technical result is achieved by the fact that the claimed mode of invisible observation in the online learning process is characterized by the fact that the teacher, student and parents or other legal representatives of the student take part in the online learning process, while parents or other legal representatives of the student can observe the learning process, characterized in that the teacher and student do not know whether parents or other legal representatives of the student are watching the online learning process, when parents or other legal representatives of the student begin and end the observation, moreover, an online training session can be recorded for its subsequent viewing and analysis by the parents or other legal representatives of the student.

### DETAILED DESCRIPTION OF THE INVENTION

In contrast to the analogues applied for registration technical solution “the invisible Mode of monitoring the process of online learning,” provides an opportunity to participate in the process of online learning parents or other legal representatives of students as observers, and the teacher and the student are not aware whether online learning session is being monitored by parents or other legal representatives of students at the moment, And the session online learning can be recorded for later viewing by parents or other legal representatives of students for further analysis.

The claimed mode of invisible observation in the process of online learning allows us to solve the technical problem of insufficient efficiency and productivity of online learning caused by the individual nature of this training, including when it can be carried out at home, because of which the teacher and student are distracted from the subject of training, are not sufficiently concentrated, and also caused by the lack of a system for monitoring the quality of the teacher's work.

Accordingly, the technical result of the claimed technical solution “Invisible observation mode in the process of online learning” is that it allows you to increase the efficiency and productivity of the online learning process, since the teacher and the student do not know about that the parents or other legal representatives of the student are watching the learning process at the moment, and therefore they get the impression that the parents or other legal representatives of the student are constantly watching the process, which helps to improve the student's concentration, and the teacher is not distracted from the subject and the training plan. At the same time, the online learning record allows parents or other legal representatives of the student to analyze the learning process in detail and make appropriate recommendations to improve the efficiency and productivity of the online learning process.

The technical result is achieved by the fact that the claimed mode of invisible observation in the online learning process is characterized by the fact that the teacher, student and parents or other legal representatives of the student take part in the online learning process, while parents or other legal representatives of the student can observe the learning process, characterized in that the teacher and student do not know whether parents or other legal representatives of the student are watching the online learning process, when parents or other legal representatives of the student begin and end the observation, moreover, an online training session can be recorded for its subsequent viewing and analysis by the parents or other legal representatives of the student.

To obtain a technical result, the invention can be carried out as follows. A is a student, and B is a teacher. B conducts online training for A. At this time, parents or other legal representatives of the student can observe the online learning process, including through webcams A and B. At the same time, neither A nor B know whether the student's parents or other legal representatives are watching them at any given time, whether they have started or finished monitoring, which creates the impression for A and B that the student's parents or other legal representatives are observing and analyzing the online learning process constantly and continuously. In this case, the online training session can be recorded, and the recording becomes available to the parents or other legal representatives of the student for subsequent viewing and analysis.

The presented invention differs in that as a result of the application of this mode of invisible observation in the process of online learning by parents or other legal representatives of the student for the online learning process between the teacher and the student, the efficiency and productivity of the online learning process increases, since the teacher and the student do not know whether parents or other legal representatives of the student are watching the online learning process at the moment, at the same time, the online learning record allows parents or other legal representatives of the student to analyze the online learning process in detail and make appropriate recommendations to improve the efficiency and productivity of the online learning process.

I claim:

1. The claimed mode of invisible observation in the online learning process is characterized by the fact that the teacher, student and parents or other legal representatives of the student take part in the online learning process, while the parents or other legal representatives of the student can observe the learning process, characterized in that the teacher and student do not know whether the parents or other legal representatives of the student are watching the online learning process, when the parents or other legal representatives of the student begin and end the observation, moreover, an online training session can be recorded for its subsequent viewing and analysis by the parents or other legal representatives of the student.
